(19) United States
(12) Patent Application Publication
(10) Pub. No.: US 2026/0225470 A1
(43) Pub. Date: Aug. 6, 2026

(54) ENERGY TRANSFER SYSTEM CONFIGURABLE BETWEEN CHARGING MODE AND POWERING MODE

(71) Applicant: Caterpillar Inc., Peoria, IL (US)

(72) Inventors: Geoffrey Mart, Chalmers, IN (US); Pratyush Pani, Chennai (IN); Bharadwaj Kaka, Bangalore (IN); Dachuan Yu, Dunlap, IL (US); Zeljko Jankovic, Mequon, WI (US); Qing Ye, Katy, TX (US)

(73) Assignee: Caterpillar Inc., Peoria, IL (US)

(21) Appl. No.: 19/047,090

(22) Filed: Feb. 6, 2025

(51) Int. Cl. B60L 50/53; B60L 50/60; B60L 53/14; B60L 53/68

(52) U.S. Cl. CPC B60L 50/53; B60L 50/60; B60L 53/14; B60L 53/68; B60L 2200/40; B60L 2210/30

(57) ABSTRACT

An energy transfer system, including a configurable energy transfer interface, a plurality of sets of inverters, and a three-winding transformer, is disclosed. The configurable energy transfer interface includes a plurality of switches coupled DC voltage outputs of the plurality of sets of inverters. The plurality of switches is capable of connecting the DC voltage outputs of the plurality of sets of inverters to provide a first DC output voltage and a second DC output voltage for charging batteries of a work machine. The plurality of switches is also capable of connecting the DC voltage outputs of the plurality of sets of inverters in series to provide to provide high DC voltage output for operating the work machine.

### TECHNICAL FIELD

The present disclosure relates to an energy transfer system configurable between a charging mode and a powering mode, and more specifically to an energy transfer system configurable between a current-source mode in a parallel configuration for charging batteries and a voltage-source mode in a series configuration for powering an electric motor of a moving machine.

### BACKGROUND

Heavy work machines, such as earth-moving vehicles or hauling trucks, require significant power to carry out their functions. The machines themselves can be of substantial weight, and their loads require large amounts of power to move. Diesel engines traditionally provide that power, but they can have disadvantages. For instance, supplies of diesel fuel may be far away from a haul route or work location, and diesel machines can generate significant pollution.

Electrically powered machines can provide many advantages over diesel machines, but also pose some challenges. The electric engine and components in the work machine require significant electrical power at different voltage levels. For instance, to propel machines along a predetermined haul route, an electrical substation may deliver several megawatts at up to 3000 VDC through power rails to sliding contactors on the electrically powered machines as the machines move. Onboard batteries may propel the electric machines outside the haul route and drive ancillary components, but those batteries need to be charged periodically at several megawatts and up to 4800 ADC. Balancing these demands presents a challenge for a substation.

Moreover, an electrical substation, or an energy transfer system, transferring DC power to a conductor such as a rail for powering electric motors in a moving machine or to a cable for charging batteries in a stationary machine needs to be portable and consolidated. A mine site, for instance, typically exists in a remote and rugged environment with access only to alternating current (AC) from medium-voltage distribution lines. As a result, equipment in a substation to transform and convert the medium-voltage AC power to lower voltage DC power usable by the work machines must be shipped to the work site. As the mining, logging, or other activity at the site evolves, the substation may need to be relocated. Consolidation of the powering and charging functions into the same equipment would increase the speed and efficiency of shipping, commissioning, and decommissioning the substation.

One arrangement for transferring power to an electric vehicle is described in U.S. Pat. No. 10,300,803 (“the '803 patent”). The '803 patent describes an inductive power system for transferring electric power from primary windings on a wayside control unit to primary windings on an electric vehicle to charge a traction battery of the vehicle or to power the vehicle. The primary and secondary windings form a high-frequency transformer, and varying a size of a gap between the primary and secondary windings can adjust a voltage rectified in the vehicle based on the charging characteristics of the traction battery. Among other things, the system of the '803 patent does not address the challenges of providing different levels of high DC voltage and high DC current by the same configurable equipment, nor does it address the space and portability constraints of a substation in a remote location. As a result, the inductive power transfer system of the '803 patent is not desirable as a unit for transferring high-voltage DC power that is configurable in the field between a charging mode and a powering mode.

Examples of the present disclosure are directed to overcoming deficiencies of such systems.

### SUMMARY

In an aspect of the present disclosure, a configurable energy transfer interface is provided. The configurable energy transfer interface includes a first positive switch having a first positive switch input configured to receive first positive DC voltage of first DC voltage and a first positive switch output configured to provide the first positive DC voltage when the first positive switch is closed; a first negative switch having a first negative switch input configured to receive first negative DC voltage of the first DC voltage and a first negative switch output configured to provide the first negative DC voltage when the first negative switch is closed; a second positive switch having a second positive switch input configured to receive second positive DC voltage of second DC voltage and a second positive switch output configured to provide the second positive DC voltage when the second positive switch is closed; a second negative switch having a second negative switch input configured to receive second negative DC voltage of the second DC voltage and a second negative switch output configured to provide the second negative DC voltage when the second negative switch is closed; a rail positive switch having a rail positive switch input coupled to the first positive switch input to receive the first positive DC voltage and a rail positive switch output configured to provide the first positive DC voltage when the rail positive switch is closed; a rail negative switch having a rail negative switch input coupled to the second negative switch input to receive the second negative DC voltage and a rail negative switch output configured to provide the second negative DC voltage when the rail negative switch is closed; and a rail series switch having a rail series switch input coupled to the first negative switch input to receive the first negative DC voltage and a rail series switch output coupled to the second positive switch input to connect the first negative switch input and the second positive switch input to provide the first DC voltage and the second DC voltage in series when the rail series switch is closed.

In another aspect of the present disclosure, an energy transfer system is provided. The energy transfer system includes a configurable energy transfer interface, a first plurality of inverters, a second plurality of inverters, and a three-winding transformer. The configurable energy transfer interface includes a first positive switch having a first positive switch input configured to receive first positive DC voltage of first DC voltage and a first positive switch output configured to provide the first positive DC voltage when the first positive switch is closed; a first negative switch having a first negative switch input configured to receive first negative DC voltage of the first DC voltage and a first negative switch output configured to provide the first negative DC voltage when the first negative switch is closed; a second positive switch having a second positive switch input configured to receive second positive DC voltage of second DC voltage and a second positive switch output configured to provide the second positive DC voltage when the second positive switch is closed; a second negative switch having a second negative switch input configured to receive second negative DC voltage of the second DC voltage and a second negative switch output configured to provide the second negative DC voltage when the second negative switch is closed; a rail positive switch having a rail positive switch input coupled to the first positive switch input to receive the first positive DC voltage and a rail positive switch output configured to provide the first positive DC voltage when the rail positive switch is closed; a rail negative switch having a rail negative switch input coupled to the second negative switch input to receive the second negative DC voltage and a rail negative switch output configured to provide the second negative DC voltage when the rail negative switch is closed; and a rail series switch having a rail series switch input coupled to the first negative switch input to receive the first negative DC voltage and a rail series switch output coupled to the second positive switch input to connect the first negative switch input and the second positive switch input to provide the first DC voltage and the second DC voltage in series when the rail series switch is closed. The first plurality of inverters includes a first positive DC output coupled to the first positive switch input and a first negative DC output coupled to the first negative switch input. The second plurality of inverters includes a second positive DC output coupled to the second positive switch input and a second negative DC output coupled to the second negative switch input. The three-winding transformer is configured to receive AC power from an external AC source, and includes a primary winding configured to couple to the external AC source, a secondary winding coupled to the first plurality of inverters, and a tertiary winding coupled to the second plurality of inverters.

In yet another aspect of the present disclosure, a method for operating an energy transfer system is provided. The method includes receiving first positive DC voltage of first DC voltage by a first positive switch input of a first positive switch of a configurable energy transfer interface and a rail positive switch input of a rail positive switch of the configurable energy transfer interface; receiving first negative DC voltage of the first DC voltage by a first negative switch input of a first negative switch of the configurable energy transfer interface and a rail series switch input of a rail series switch of the configurable energy transfer interface; receiving second positive DC voltage of second DC voltage by a second positive switch input of a second positive switch of the configurable energy transfer interface and a rail series switch output of the rail series switch; receiving second negative DC voltage of the second DC voltage by a second negative switch input of a second negative switch of the configurable energy transfer interface and a rail negative switch input of a rail negative switch of the configurable energy transfer interface; in a bulk charging mode of the configurable energy transfer interface, closing the first positive switch to provide the first positive DC voltage at a first positive switch output of the first positive switch, closing the first negative switch to provide the first negative DC voltage at a first negative switch output of the first negative switch, closing the second positive switch to provide the second positive DC voltage at a second positive switch output of the second positive switch, and closing the second negative switch to provide the second negative DC voltage at a second negative switch output of the second negative switch; and in a dynamic energy transfer (DET) mode of the configurable energy transfer interface, closing the rail positive switch to provide the first positive DC voltage at a rail positive switch output of the rail positive switch, closing the rail negative switch to provide the second negative DC voltage at a rail negative switch output of the rail negative switch, and closing the rail series switch to connect the first negative switch input and the second positive switch input to provide the first DC voltage and the second DC voltage in series.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 is a schematic illustration of an electrically powered work machine coupled to a roadside power source in accordance with an example of the present disclosure.

FIG. 2 is a front-side view of an energy transfer system in accordance with an example of the present disclosure.

FIG. 3 is a schematic diagram of the energy transfer system in accordance with an example of the present disclosure.

FIG. 4 is a schematic diagram of a modular cabinet utilized in the energy transfer system of FIG. 3 in accordance with an example of the present disclosure.

FIG. 5 is a schematic diagram of the energy transfer system in a bulk charging mode in accordance with an example of the present disclosure.

FIG. 6 is a schematic diagram of the energy transfer system in a dynamic energy transfer (DET) mode in accordance with an example of the present disclosure.

FIG. 7 is a flow chart illustrating a process for operating the energy transfer system in accordance with an example of the present disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. For the purpose of this disclosure, the term “ground surface” is broadly used to refer to all types of surfaces or materials that may be worked in material moving procedures (e.g., gravel, clay, sand, dirt, etc.) and/or can be cut, spread, sculpted, smoothed, leveled, graded, or otherwise treated. In this disclosure, unless stated otherwise, relative terms, such as, for example, “about,” “substantially,” and “approximately” are used to indicate a possible variation of ±10% in the stated value.

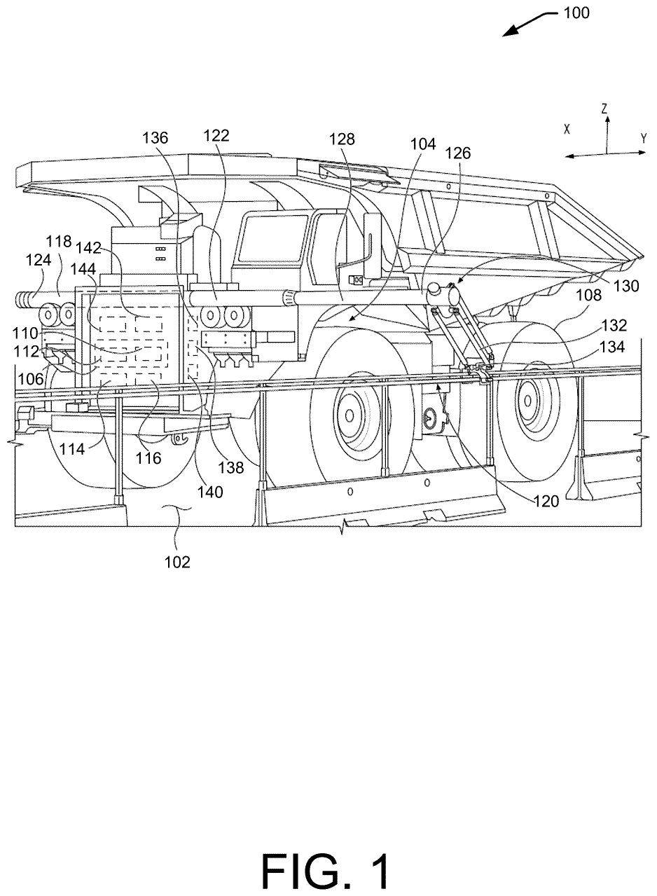

FIG. 1 illustrates an isometric view of an example work machine 100 within an XYZ coordinate system as one example suitable for receiving charging current and/or powering voltage from the configurable substation of this disclosure. The work machine 100 travels parallel to the X axis along a roadway, also termed a haul route 102, typically from a source to a destination within a worksite. In one implementation as illustrated, the work machine 100 is a hauling machine that hauls a load within or from a worksite within a mining operation. For instance, the work machine 100 may haul excavated ore or other earthen materials from an excavation area along the haul route 102 to dump sites and then return to the excavation area. In this arrangement, the work machine 100 may be one of many similar machines configured to ferry earthen material in a trolley arrangement. While a large mining truck in this instance, the work machine 100 may be any machine that carries a load between different locations within a worksite, examples of which include an articulated truck, an off-highway truck, an on-highway dump truck, a wheel tractor scraper, or any other similar machine. Alternatively, the work machine 100 may be an off-highway truck, on-highway truck, a dump truck, an articulated truck, a loader, an excavator, a pipe layer, or a motor grader. In other implementations, the work machine 100 need not haul a load and may be any machine associated with various industrial applications including, but not limited to, mining, agriculture, forestry, construction, and other industrial applications.

Referring to FIG. 1, and relevant to the present disclosure, the work machine 100 includes a frame 104 powered by an electric engine 106 to cause rotation of traction devices 108. The traction devices 108 are typically four or more wheels with tires, although tracks or other mechanisms for engagement with the ground along the haul route 102 are possible. The electric engine 106 provides mechanical energy to the work machine 100 based on electrical power sources, such as described in further detail below. An example of mechanical energy provided by the electric engine 106 includes propelling the traction devices 108 to cause movement of the work machine 100 along the haul route 102, but the electric engine 106 also includes components sufficient to power other affiliated operations within the work machine 100. For instance, in some implementations, the electric engine 106 includes equipment for converting electrical energy to provide pneumatic or hydraulic actions within the work machine 100. While the electric engine 106 is configured to operate from an external electrical power source, the electric engine 106 typically includes one or more batteries for storing electrical energy for auxiliary or backup operations, as discussed in more detail below.

The electric engine 106 includes one or more motors 110 responsible for generating torque to propel the work machine 100. The motors 110 may be of any suitable type, such as induction motors, permanent magnet motors, switched reluctance (SR) motors, combinations thereof, or the like. The motors 110 are of any suitable voltage, current, and/or power rating. The motors 110 when operating together are configured to propel the work machine 100 as needed for tasks that are to be performed by the work machine 100. For example, the motors 110 may be rated for a range of about 500V to about 3000V. A motor controller 112 includes control electronics configured to control the operation of the motors 110. In some cases, each motor 110 may be controlled by its own motor controller 112. In other cases, all the motors of the work machine 100 may be controlled by a single motor controller 112. The motor controller 112 may further include one or more inverters or other circuitry to control the energizing of magnetic flux generating elements (e.g., coils) of the motors 110. The motors 110 are mechanically coupled to a variety of drive train components, such as a drive shaft and/or axles or directly to the traction devices 108 to propel the work machine 100. Although not shown here, there may be one or more motors that are not used for propulsion of the work machine 100, but rather to operate pumps and/or other auxiliary components, such as to operate hydraulic systems.

According to examples of the disclosure, electrical power to energize the motors 110 is received from a battery module 114. The battery module 114 may provide power for operating the motors 110 and/or other power consuming components (e.g., controllers, cooling systems, displays, actuators, sensors, etc.) of the work machine 100. The presently disclosed subject matter is not limited solely to the use of battery power, as other forms of energy may be used in conjunction with the power provided by the battery module 114, including, but not limited to, internal combustion engines or fuel cells, and external electrical sources discussed further below.

The battery module 114 may be of any suitable type and capacity. The battery module 114 includes one or more cells, that when electrically connected, operate as a battery to provide the voltage, current, and/or power requirements of the work machine 100. For example, the battery module 114 may include cells forming a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. A battery controller 116 monitors and controls various aspects of the battery module 114, such as controlling a temperature of the battery, the prevention of an over discharge condition, and charging characteristics and demands.

In addition to, or alternative to, obtaining electrical energy from the battery module 114, the electric engine 106 may obtain electrical energy from an external source. For example, the work machine 100 further includes a conductor rod 118 configured to receive electrical power from power rails 120. In some examples, the power rails 120 are one or more beams of metal arranged substantially parallel to and a distance above the ground. In FIG. 1, the power rails 120 are positioned to be substantially parallel to the X axis and the direction of travel of the work machine 100. Support mechanisms hold the power rails 120 in place along a distance at the side of the haul route 102 for the work machine 100 to traverse. While shown in FIG. 1 to the left of the work machine 100 as the work machine 100 travels in the direction of the X axis, the power rails 120 may be installed to the right of the work machine 100 or in other locations suitable to the implementation.

The power rails 120 provide a source of electrical power for the work machine 100 as either AC or DC. In some examples, the power rails 120 have two or more conductors, each providing voltage and current at a different electrical pole. In one implementation (e.g., an implementation in which the power rails 120 include three conductors), one conductor provides positive DC voltage, a second conductor provides negative DC voltage, and a third conductor provides an electrical or earth ground, i.e., 0V relative to the other two conductors. The two powered conductors within the power rails 120 can provide a variety of voltage levels, such as a voltage difference greater than 2500V, which may be delivered as +1500 VDC and −1500 VDC in one example to provide 3000 VDC. These values are exemplary, and other physical and electrical configurations for the power rails 120 are available and within the knowledge of those of ordinary skill in the art.

The conductor rod 118 enables electrical connection between the work machine 100 and the power rails 120, including during movement of the work machine 100 along the haul route 102. In the example shown in FIG. 1, the conductor rod 118 is an elongated arm resembling a pole. FIG. 1 shows the conductor rod 118 positioned along a front side of the work machine 100, with respect to the direction of travel of the work machine 100 in the direction of the X axis. As embodied in FIG. 1, the conductor rod 118 includes a barrel 122 mounted to the frame 104 of the work machine 100. The barrel 122 has a hollow interior and may be a conductive metal having suitable mechanical strength and resiliency, such as aluminum. Within, and possibly including the barrel 122, the conductor rod 118 includes a series of electrical conductors passing longitudinally, at least from a head 124 at a proximal end to a tip 126 at a distal end. Tubular conductors within an arm 128 slidably engage with corresponding tubular conductors within the barrel 122 to maintain electrical continuity as the arm 128 is extended or retracted. In other examples, the conductor rod 118 may comprise a boom with a trailing or a folding arm that is selectively movable with respect to the frame 104 between a retracted position and an extended position. The boom may be pivotably connected to the frame 104, while the trailing arm may be capable of being contracted or folded in a storage configuration when not in use.

At a position away from the work machine 100 at the tip 126, a connector assembly 130 provides an interface to the power rails 120 via trailing arms 132 and a contactor 134. The power rails 120 are typically arranged along a side of the haul route 102, and the work machine 100 is steered so that it traverses the haul route 102 substantially in parallel with the power rails 120. The contactor 134 may include multiple degrees of freedom to allow the contactor 134 to align and ride on top of the power rails 120. In operation, electrical power is accessed from the power rails 120 via the contactor 134, and the electrical power is conducted through the trailing arms 132 into the connector assembly 130 and to the work machine 100 for powering the electric engine 106 and otherwise enabling operations within the work machine 100.

The different voltages provided by the battery module 114 and the power rails 120, along with other voltages used within the work machine 100, may be distributed within the work machine 100 on two or more voltage buses. In one example, the work machine 100 has two voltage buses, a battery bus 136 and an accessory bus 138. In this situation, a traction system (not shown) within the work machine 100 for propelling the traction devices 108 may be configured to operate from a voltage level V1 provided by the battery module 114. This battery voltage V1 may be greater than 700 volts, such as 750 VDC-1500 VDC, which would be provided on the battery bus 136 from the battery module 114 at least to the traction system within the work machine 100. Electrical accessories within the work machine 100, such as a water pump, an electric fan, a heating, ventilation, and air conditioning (HVAC) system, or a battery management system (BMS), typically require a lower voltage, so the battery voltage V1 is converted within the work machine 100 to a lower DC voltage V2, such as 550 VDC-700 VDC, for distribution on the accessory bus 138. In this two-bus example, a high voltage V3 received from an external source, namely, the power rails 120 providing a voltage difference greater than 2500 VDC, such as 2600 VDC-3000 VDC, would be stepped down to match the battery voltage V1 and then joined into the battery bus 136.

In another example, the work machine 100 has three voltage buses—the battery bus 136, the accessory bus 138, and a traction bus 140. In this situation, the traction system may be configured to operate from voltage level V3 provided by the power rails 120, i.e., at about 2600 VDC-3000 VDC. As a result, battery voltage V1 on the battery bus 136 is stepped up to match voltage level V3, i.e., traction voltage V3 on the traction bus 140. Thus, in this example, the traction bus 140 carries about 2600 VDC-3000 VDC, while the battery bus 136 carries battery voltage V1 of about 1100 VDC-1500 VDC, and the accessory bus 138 carries a lesser voltage V2 of about 550 VDC-700 VDC. The voltages for each of these buses are exemplary only and other voltage values and ranges may be adopted without departing from the principles of this disclosure.

In some examples, the work machine 100 includes one or more interfaces, such as a first charge port 142 and a second charge port 144, for receiving electrical energy from an external source to charge the battery module 114. As discussed in further detail below, the external source may be a fast-charging circuit that can charge the battery module 114 in 20-30 minutes, for example, when the work machine 100 is stationary. The first charge port 142 and the second charge port 144 are coupled to the battery bus 136 to provide, separately or together, sufficient charging current from the external source at battery voltage V1 while the work machine 100 is out of service.

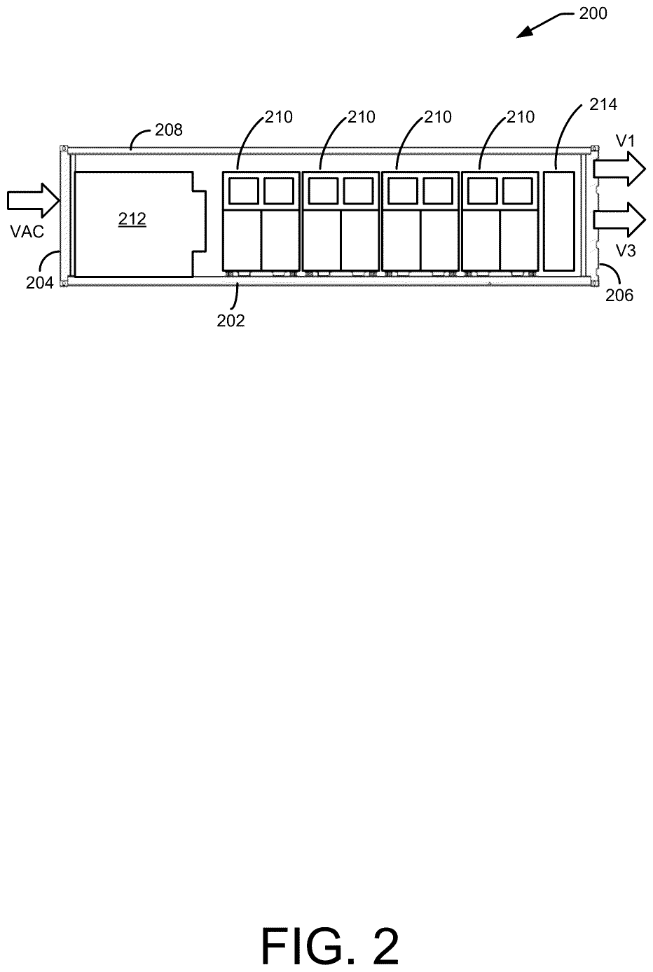

FIG. 2 is an isometric view of an example energy transfer system 200 for transferring electrical energy to the work machine 100 suitable for carrying out the principles discussed in the present disclosure. In one configuration, the energy transfer system 200 provides DC electrical energy for powering the electric engine 106 to cause movement of the work machine 100, such as by providing voltage V3 to the work machine 100 via the power rails 120. In another configuration, the energy transfer system 200 provides DC electrical energy for charging the battery module 114 while the work machine 100 is stationary, such as by providing voltage V1 to the work machine 100 via one or more of charge ports, such as the first charge port 142 and the second charge port 144.

As illustrated in FIG. 2, the energy transfer system 200 in some examples includes an external structure with walls and a roof to protect its equipment from the environment and to protect personnel from hazardous voltages. The energy transfer system 200 receives AC voltage from an external source (not shown), such as AC distribution power denoted VAC as an input in FIG. 2, and transforms and conditions that AC voltage into different levels of DC voltage, such as outputs V1 and V3 in FIG. 2. The converted DC voltages are then provided for use by a load (not shown), such as the work machine 100. While not shown, the energy transfer system 200 may house a transformer configured to couple to an external AC source, a plurality of modular cabinets coupled to the transformer, each modular cabinet comprising one or more sets of inverters for converting AC voltage from the transformer to DC voltage, an interface box for controlling the DC voltage from the plurality of cabinets to produce desired output DC voltage, such as V1 for charging the battery module 114 via the first charge port 142 and the second charge port 144 and V3 for powering the work machine 100 via the power rails 120.

The energy transfer system 200 may be located in any environment requiring DC distribution voltage, particularly situations in which the substation may be periodically commissioned, decommissioned, and relocated. The energy transfer system 200 is essentially self-contained and suited for environments where electrical equipment and related resources may otherwise be lacking. In some examples, the environment for the energy transfer system 200 is a mine site or a logging site in a remote location, and the load is the work machine 100 powered by the DC voltage to haul a load. In other implementations, the heavy work machine need not haul a load and may be any machine associated with various industrial applications including, but not limited to, mining, agriculture, forestry, construction, and other industrial applications.

As illustrated in FIG. 2, the energy transfer system 200 is cuboid in shape, although other forms for the energy transfer system 200 are possible depending on the implementation. The exterior structure includes a base 202, a front wall (not shown), a rear wall on the opposite side of the front wall (not shown), a first end wall 204, a second end wall 206, and a roof 208. One or more doors within the walls of the energy transfer system 200 provide access to the interior of the structure. Due to heat generated by electrical equipment within the energy transfer system 200 described below, several air-conditioning units cool the interior and may form part of one or more walls. In some examples, the energy transfer system 200 is elevated from ground by support structures, such as piers (not shown). The piers may be of any shape or composition and serve to hold the energy transfer system 200 above the ground. In some examples, the piers are about 1.0 meter in height.

In some examples, the energy transfer system 200 is a modular and portable structure. To facilitate shipment, the energy transfer system 200 is intended to have an external size sufficient when assembled to fit within, i.e., to conform to the internal dimensions of, a shipping container of standard size. In one example, a Series 1AAA standard “high cube” intermodal shipping container according to International Organization for Standardization (ISO) standard 668:2020, has a length of 40 feet (12.19 meters), a width of eight feet (2.44 meters), and a height of 9.6 feet (2.5 meters). As a result, the energy transfer system 200 may be loaded in one example into a shipping container conforming to ISO 668:2020, shipped to a location within a work site, unloaded, and configured for operation with minimal additional parts or setup activities. Similarly, the energy transfer system 200 may be decommissioned from the location and readily moved intact to a new destination, such as another location within the site as work evolves. Shipping containers of other sizes and standards are also possible for transporting the energy transfer system 200 based on the size and electrical performance of the equipment and the logistics of moving the energy transfer system 200 between locations.

The energy transfer system 200 may include a plurality of modular cabinets 210, each including a plurality of inverters (not shown), receiving AC power from a transformer 212. The energy transfer system 200 may generate V1 and V3 from outputs of the plurality of modular cabinets 210 through a configurable energy transfer interface 214, and supply one or more of V1 and V3 through electrical conductors coupled to the work machine 100. In some examples, the transformer 212 of the energy transfer system 200 receives an AC voltage input VAC generally in the range of 11 kV to 33 kV three-phase AC electricity at 50 Hz or 60 Hz from an external source such as an AC medium-voltage distribution line. In one mode, in which the energy transfer system 200 functions as an Energy Transfer Unit (ETU), the energy transfer system 200 may transform and convert the AC voltage input to a DC voltage output V1 of up to 1500 VDC at about 4800 A of current at about 6 MW of power, which may be used to charge batteries of a stationary vehicle. In this situation, the energy transfer system 200 may operate as a current source and provide stable electrical current at voltage V1 to one or both of the first charge port 142 and the second charge port 144 through cables or similar conductors while the work machine 100 is out of service. In another mode, the energy transfer system 200 may provide Dynamic Energy Transfer (DET) to a vehicle in motion, transforming the AC voltage input to a DC voltage output V3 of up to 3000 VDC at about 3600 A of current and about 6 MW of power. In this situation, the energy transfer system 200 can operate as a voltage source and provide stable electrical voltage at V3 (or in some implementations, at V1) to the power rails 120, which may be accessed by the contactors 134 on the work machine 100. It should be noted that the AC voltage input ranges and/or the DC voltage output ranges are examples, and the present disclosure contemplates other suitable values of the AC voltage input and/or the DC voltage output.

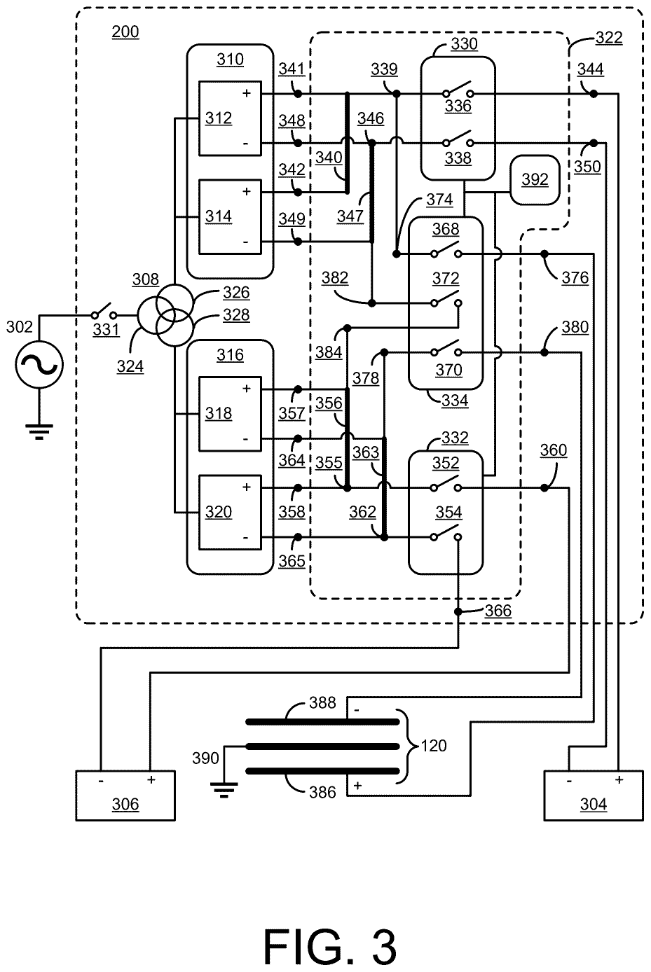

FIG. 3 is a block diagram of the energy transfer system 200 shown with an external AC power source 302, a first dispenser 304, a second dispenser 306, and the power rails 120. As described above with reference to FIGS. 1 and 2, the power rails 120 may be accessed by the contactors 134 on the work machine 100, and the first dispenser 304 and the second dispenser 306 may be connected to the first charge port 142 and the second charge port 144, respectively, for charging the battery module 114 of the work machine 100.

The energy transfer system 200 may comprise a three-winding transformer 308, a first modular cabinet 310 including a first plurality of inverters (shown with a first set of inverters 312 and a second set of inverters 314), a second modular cabinet 316 including a second plurality of inverters (shown with a third set of inverters 318 and a fourth set of inverters 320), and a configurable energy transfer interface 322. The first modular cabinet 310 and the second modular cabinet 316 may be the same in construction and be interchangeable. While the first modular cabinet 310 and the second modular cabinet 316 are each shown with two sets of inverts, any number of sets of inverters may be implemented to meet a desired output, such as the power required to operate the work machine 100 via the power rail 120 and/or to charge the battery module 114 via the first charge port 142 and the second charge port 144. Each modular cabinet includes the same number of sets of inverters and each set of inverters include the same number of inverters. For example, each set of the first set of inverters 312, the second set of inverters 314, the third set of inverters 318, and the fourth set of inverters 320 may include the same number of inverters with the same type and capacity. While positive outputs and negative outputs of the first set of inverters 312 and the second set of inverters 314 are shown as connected within the first modular cabinet 310, these connections may also be made outside of the first modular cabinet 310. For example, each inverter of the first set of inverters 312 and the second set of inverters 314 may connect to a common positive bus and a common negative bus inside or outside of the first modular cabinet 310. Inverters of the third set of inverters 318 and the fourth set of inverters 320 may similarly be connected. In this example, the first set of inverters 312, the second set of inverters 314, the third set of inverters 318, and the fourth set of inverters 320 are shown as each having one inverter.

The three-winding transformer 308 may comprise a primary winding 324, a secondary winding 326, and a tertiary winding 328. The primary winding 324 may be coupled to the external AC power source 302, which may be an electrical grid or a distribution line, via a main power switch 331 to receive AC power having AC voltage in the range of 11 kV to 33 kV at 50 Hz or 60 Hz. The secondary winding 326 may be coupled to the first modular cabinet 310 and the tertiary winding 328 may be coupled to the second modular cabinet 316. The secondary winding 326 and the tertiary winding 328 may provide substantially the same amount of AC power to the first modular cabinet 310 and the second modular cabinet 316. DC outputs from the first modular cabinet 310 and the second modular cabinet 316 are coupled to the configurable energy transfer interface 322, which arranges the DC outputs to provide desired or required power output to operate the work machine 100 via the power rail 120 or to charge the battery module 114 via the first charge port 142 and the second charge port 144.

The configurable energy transfer interface 322 may comprise a first switch 330, a second switch 332, and a rail switch 334. The first switch 330 may comprise a first positive switch 336 and a first negative switch 338. The first positive switch 336 may include a first positive switch input 339 coupled to a first positive DC terminal 340, which is coupled to, and receives first positive DC voltage of first DC voltage from, a positive output 341 of the first set of inverters 312 and a positive output 342 of the second set of inverters 314. The first positive switch 336 provides the first positive DC voltage at a first positive switch output 344 when the first positive switch 336 is closed. The first negative switch 338 may include a first negative switch input 346 coupled to a first negative DC terminal 347, which is coupled to, and receives first negative DC voltage of the first DC voltage from, a negative output 348 of the first set of inverters 312 and a negative output 349 of the second set of inverters 314. The first negative switch 338 provides the first negative DC voltage at the first negative switch output 350 when the first negative switch 338 is closed. The first DC voltage, such as V1, from the first switch 330 may be provided to the first dispenser 304, which may, for example, be connected to the first charge port 142 to charge the battery module 114 of the work machine 100.

The second switch 332 may include a second positive switch 352 and a second negative switch 354. The second positive switch 352 may include a second positive switch input 355 coupled to a second positive DC terminal 356, which is coupled to, and receives second positive voltage of second DC voltage from, a positive output 357 of the third set of inverters 318 and a positive output 358 of the fourth set of inverters 320. The second positive switch 352 provides the second positive DC voltage at a second positive switch output 360 when the second positive switch 352 is closed. The second negative switch 354 may include a second negative switch input 362 coupled to a second negative DC terminal 363, which is coupled to, and receives second negative DC voltage of the second DC voltage from, a negative output 364 of the third set of inverters 318 and a negative output 365 of the fourth set of inverters 320. The second negative switch 354 provides the second negative voltage at the second negative switch output 366 when the second negative switch 354 is closed. The second DC voltage, which may the same as the first DC voltage such as V1, from the second switch 332 may be provided to the second dispenser 306, which may, for example, be connected to the second charge port 144 to charge the battery module 114 of the work machine 100.

The rail switch 334 may comprise a rail positive switch 368, a rail negative switch 370, and a rail series switch 372. The rail positive switch 368 may include a rail positive switch input 374 coupled to the first positive switch input 339 to receive the first positive DC voltage, and a rail positive switch output 376 to provide the first positive DC voltage at the rail positive switch output 376 when the rail positive switch 368 is closed. The rail negative switch 370 may include a rail negative switch input 378 coupled to the second negative switch input 362 to receive the second negative DC voltage, and a rail negative switch output 380 to provide the second negative DC voltage at the rail negative switch output 380 when the rail negative switch 370 is closed. The rail series switch 372 may include a rail series switch input 382 coupled to the first negative switch input 346 to receive the first negative DC voltage, and a rail series switch output 384 coupled to the second positive switch input 355 to connect the first negative switch input 346 and the second positive switch input 355 in series when the rail series switch 372 is closed. Third DC voltage, such as V3 resulting from combining the first DC voltage and the second DC voltage in series, from the rail switch 334 may be provided to the power rails 120 by providing third DC positive voltage of the third DC voltage from the rail positive switch output 376 to a positive rail 386 of the power rails 120 and third DC negative voltage of the third DC voltage from the rail negative switch output 380 to a negative rail 388 of the power rails 120. The power rail 120, having a ground connection 390, may, for example, be connected to the contactor 134 of the work machine 100 to supply DC power to enable operation of the work machine 100.

The configurable energy transfer interface 322 may be configured based on operation of the first switch 330, the second switch 332, and the rail switch 334. When the first switch 330 is open, the first positive switch 336 and the first negative switch 338 are open, and when the first switch 330 is closed, the first positive switch 336 and the first negative switch 338 are closed. When the second switch 332 is open, the second positive switch 352 and the second negative switch 354 are open, and when the second switch 332 is closed, the second positive switch 352 and the second negative switch 354 are closed. When the rail switch 334 is open, the rail positive switch 368, the rail negative switch 370, and the rail series switch 372 are open, and when the rail switch 334 is closed, the rail positive switch 368, the rail negative switch 370, and the rail series switch 372 are closed. In a bulk charging mode, the first switch 330 and the second switch 332 are closed and the rail switch 334 is open, and the first DC voltage is provided to the first dispenser 304 and the second DC voltage is provided to the second dispenser 306 while the power rails 120 receives no power. In a dynamic energy transfer (DET) mode, the first switch 330 and the second switch 332 are open and the rail switch 334 is closed, and the third DC voltage is provided to the power rails 120 while the first dispenser 304 and the second dispenser 306 receive no power.

The configurable energy transfer interface 322 may further comprise a switch controller 392 coupled to the first switch 330, the second switch 332, and the rail switch 334 configured to control the operation of the first switch 330, the second switch 332, and the rail switch 334. For example, based on receiving a bulk charge activation command for the bulk charging mode, the switch controller 392 may cause the first switch 330, the second switch, and the rail switch to operate in the bulk charging mode, that is, the switch controller 392 may cause the first switch 330 and the second switch 332 to close and the rail switch 334 to open. Additionally, based on receiving a DET activation command for the DET mode, the switch controller 392 may cause the first switch 330, the second switch 332, and the rail switch 334 to operate in the DET mode, that is, the switch controller 392 may cause the first switch 330 and the second switch 332 to open and the rail switch 334 to close. Further, based on receiving a deactivation command to deactivate the DC outputs of the first switch 330, the second switch 332, and the rail switch 334, the switch controller 392 may cause the first switch 330, the second switch 332, and the rail switch 334 to open. The switch states, or positions, of the first switch 330, the second switch 332, and the rail switch 334 are shown in a deactivation state in FIG. 3. The switch controller 392 may be remotely operated wirelessly or by a cable. For example, the switch controller 392 may be controlled by a controlling device (not shown) remotely located that communicates with the switch controller 392 via a physical cable, the Internet, one or more cellular network, a local area network (LAN), wireless LAN (WLAN), Bluetooth, or any other applicable communication methods and protocols.

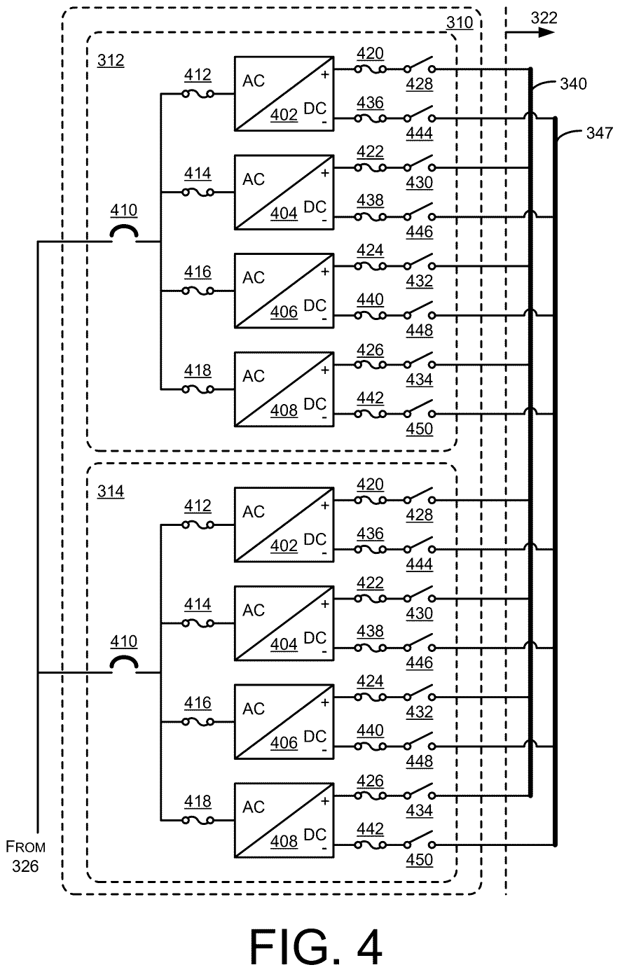

FIG. 4 is a schematic diagram of a modular cabinet, such as the first modular cabinet 310, utilized in the energy transfer system 200. As described above with reference to FIG. 3, the first modular cabinet 310 may include the first set of inverters 312 and the second set of inverters 314, and the first set of inverters 312 and the second set of inverters 314 include the same number of inverters that are the same type and capacity. In this example, four inverters 402, 404, 406, and 408 of the same type and capacity are shown in each of the first set of inverters 312 and the second set of inverters 314. The first set of inverters 312 and the second set of inverters 314 may receive AC power from the three-winding transformer 308, more specifically, from the secondary winding 326 of the three-winding transformer 308, through circuit breakers 410. The four inverters 402, 404, 406, and 408 then receive the AC power through AC fuses 412, 414, 416, and 418, respectively. The four inverters 402, 404, 406, and 408 provide positive DC voltage through respective positive DC fuses (420, 422, 424, and 426) and respective positive disconnect switches (428, 430, 432, and 434) which connect to the first positive DC terminal 340, and provide negative DC voltage through respective negative DC fuses (436, 438, 440, and 442) and respective negative disconnect switches (444, 446, 448, and 450) which connect to the first negative DC terminal 347.

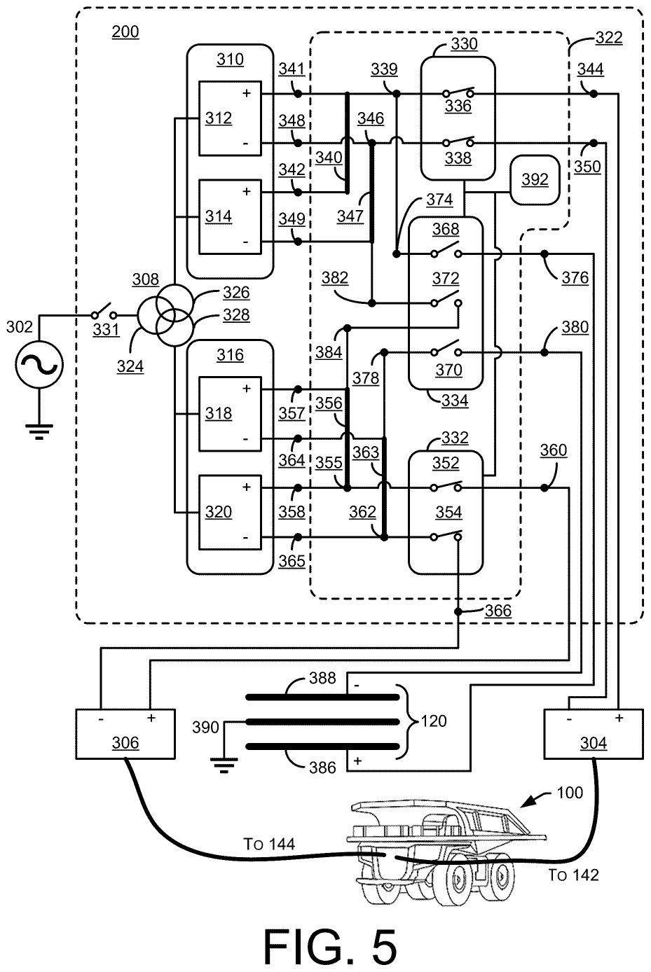

FIG. 5 is a schematic diagram of the energy transfer system 200 in the bulk charging mode. As described above with reference to FIG. 3, the first switch 330 and the second switch 332 are closed while the rail switch 334 is open as shown in the bulk charging mode. While the power rails 120 are disabled, the first dispenser 304 and the second dispenser 306 are energized in the bulk charging mode and may charge the battery module 114 of the work machine 100 via the first charge port 142 and the second charge port 144.

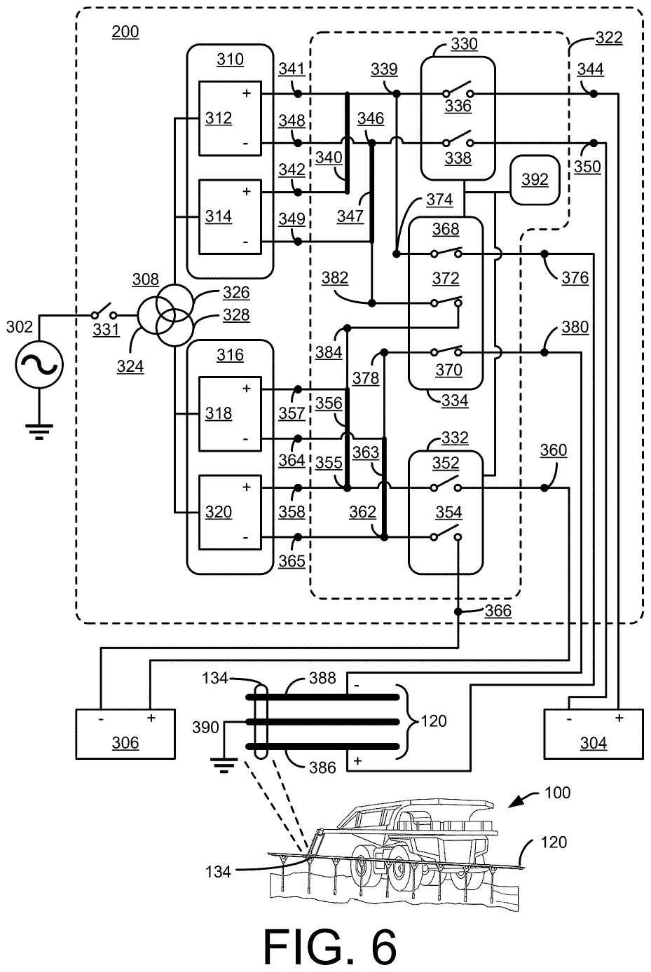

FIG. 6 is a schematic diagram of the energy transfer system 200 in the DET mode. As described above with reference to FIG. 3, the first switch 330 and the second switch 332 are open while the rail switch 334 is closed as shown in the DET mode. While the first dispenser 304 and the second dispenser 306 are disable in the DET mode, the power rails 120 are energized and may supply DC power to enable operation of the work machine 100 via the contactor 134.

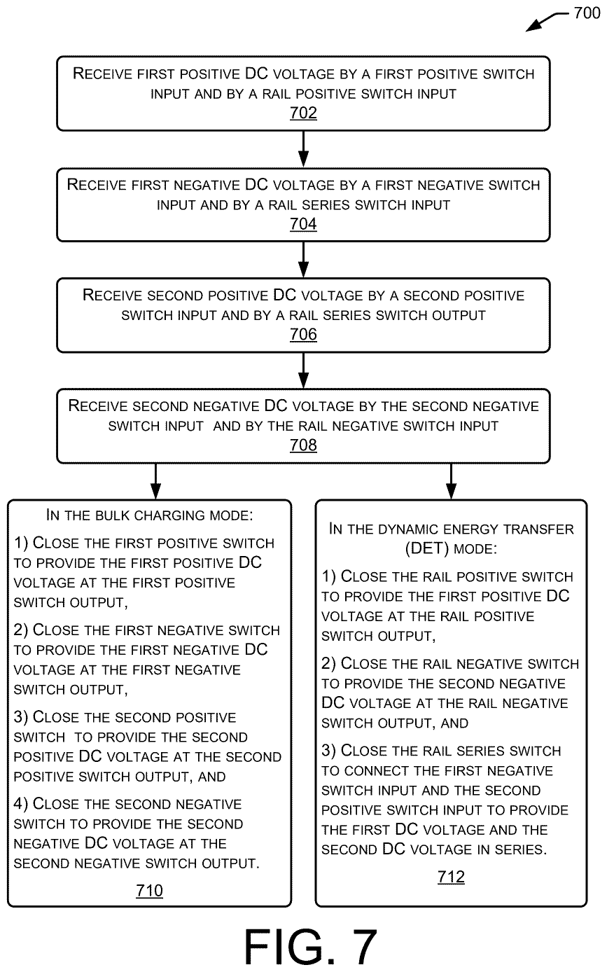

FIG. 7 is a flow chart illustrating an example process 700 for operating the energy transfer system 200 as described above with reference to FIGS. 3-6. The example process 700 is illustrated as a collection of steps in a logical flow diagram, which represents operations that can be performed in configuring the energy transfer system 200 as described above with reference to FIGS. 3-6. The order in which the operations are described is not intended to be construed as a limitation, and any number of the described steps can be combined and performed in any order, in parallel, or simultaneously to implement the process.

At block 702, first positive DC voltage of first DC voltage, such as first positive DC voltage from the positive outputs 341 and 342, may be received by, or applied to, the first positive switch input 339 of the first positive switch 336 of the configurable energy transfer interface 322 and by the rail positive switch input 374 of the rail positive switch 368 of the configurable energy transfer interface 322 by way of the first positive DC terminal 340. At block 704, first negative DC voltage of the first DC voltage, such as first negative DC voltage from the negative outputs 348 and 349, may be received by, or applied to the first negative switch input 346 of the first negative switch 338 of the configurable energy transfer interface 322 and by the rail series switch input 382 of the rail series switch 372 of the configurable energy transfer interface 322 by way of the first negative DC terminal 347. At block 706, second positive DC voltage of second DC voltage, such as second positive DC voltage from the positive outputs 357 and 358, may be received by, or applied to, the second positive switch input 355 of the second positive switch 352 of the configurable energy transfer interface 322 and the rail series switch output 384 of the rail series switch 372 by way of the second positive DC terminal 356. At block 708, second negative DC voltage of the second DC voltage, such as second negative DC voltage from the negative outputs 364 and 365, may be received by, or applied to, the second negative switch input 362 of a second negative switch 354 of the configurable energy transfer interface 322 and the rail negative switch input 378 of the rail negative switch 370 by way of the second negative DC terminal 363.

At block 710, the configurable energy transfer interface 322 may be operated in the bulk charging mode as described above with reference to FIG. 5 by closing: 1) the first positive switch 336 to provide the first positive DC voltage at the first positive switch output 344 of the first positive switch 336, 2) the first negative switch 338 to provide the first negative DC voltage at the first negative switch output 350 of the first negative switch 338, 3) the second positive switch 352 to provide the second positive DC voltage at the second positive switch output 360 of the second positive switch 352, and 4) the second negative switch 354 to provide the second negative DC voltage at the second negative switch output 366 of the second negative switch 354. In the bulk charging mode, the rail positive switch 368, the rail negative switch 370, and the rail series switch 372 may be open.

At block 712, the configurable energy transfer interface 322 may be operated in the dynamic energy transfer (DET) mode of the configurable energy transfer interface as described above with reference to FIG. 5 by closing: 1) the rail positive switch 368 to provide the first positive DC voltage at the rail positive switch output 376 of the rail positive switch 368, 2) the rail negative switch 370 to provide the second negative DC voltage at the rail negative switch output 380 of the rail negative switch 370, and 3) the rail series switch 372 to connect the first negative switch input 346 and the second positive switch input 355 to provide the first DC voltage and the second DC voltage in series. In the DET mode, opening the first positive switch 336, the first negative switch 338, the second positive switch 352, and the second negative switch 354 may be open.

As described above with reference to FIG. 3, the energy transfer system 200 may comprise a switch controller in the configurable energy transfer interface 322, such as the switch controller 392 coupled to the first positive switch 336, the first negative switch 338, the second positive switch 352, the second negative switch 354, the rail positive switch 368, the rail negative switch 370, and the rail series switch 372. The energy transfer system 200 may be operated in the bulk charging mode based on receiving a bulk charge activation command by the switch controller 392, or in the DT mode based on receiving a DET activation command by the switch controller 392. The bulk charge activation command and DET activation command may be transmitted from a controlling device remotely located from the configurable energy transfer interface 322 to the switch controller 392.

Those of ordinary skill in the field will appreciate that the principles of this disclosure are not limited to the specific examples discussed or illustrated in the figures. For example, while the energy transfer system has been discussed in the context of fitting within a standard size container for portability, the described concepts are applicable beyond the constraints of that housing. Moreover, while the megawatt power inverters are described for supplying voltage and/or current to a heavy work machine, other types of vehicles or equipment may benefit from the principles described and illustrated. As well, it will be understood that the power inverters of the disclosed energy transfer station may be coupled to one or more additional energy transfer station to attain different output capacities as a group.

### INDUSTRIAL APPLICABILITY

The present disclosure provides systems and methods for transforming AC power to DC power and provide configurable DC power output between bulk charging mode for charging batteries of a stationary work machine and a dynamic energy transfer (DET) mode for powering a moving work machine. The energy transfer system include a configurable energy transfer interface, a first plurality of inverters, a second plurality of inverters, and a three-winding transformer. The configurable energy transfer interface includes a first switch, a second switch, and a rail switch. The first switch includes 1) a first positive switch having a first positive switch input configured to receive first positive DC voltage of first DC voltage and a first positive switch output configured to provide the first positive DC voltage when the first positive switch is closed, and 2) a first negative switch having a first negative switch input configured to receive first negative DC voltage of the first DC voltage and a first negative switch output configured to provide the first negative DC voltage when the first negative switch is closed. The second switch includes 1) a second positive switch having a second positive switch input configured to receive second positive DC voltage of second DC voltage and a second positive switch output configured to provide the second positive DC voltage when the second positive switch is closed, and 2) a second negative switch having a second negative switch input configured to receive second negative DC voltage of the second DC voltage and a second negative switch output configured to provide the second negative DC voltage when the second negative switch is closed. The rail switch include 1) a rail positive switch having a rail positive switch input coupled to the first positive switch input to receive the first positive DC voltage and a rail positive switch output configured to provide the first positive DC voltage when the rail positive switch is closed, 2) a rail negative switch having a rail negative switch input coupled to the second negative switch input to receive the second negative DC voltage, and a rail negative switch output configured to provide the second negative DC voltage when the rail negative switch is closed, and 3) a rail series switch having a rail series switch input coupled to the first negative switch input to receive the first negative DC voltage and a rail series switch output coupled to the second positive switch input to connect the first negative switch input and the second positive switch input to provide the first DC voltage and the second DC voltage in series when the rail series switch is closed.

The first plurality of inverters includes a first positive DC output coupled to the first positive switch input and a first negative DC output coupled to the first negative switch input. The second plurality of inverters includes a second positive DC output coupled to the second positive switch input and a second negative DC output coupled to the second negative switch input. The three-winding transformer receives AC power from an external AC source, and include a primary winding configured to couple to the external AC source, a secondary winding coupled to the first plurality of inverters, and a tertiary winding coupled to the second plurality of inverters.

In a bulk charging mode of the energy transfer system, the first switch and the second switch are closed and the rail switch is open, and the first DC output voltage from the first plurality of inverters and the second DC output voltage from the second plurality of inverters are available at the outputs of the first switch and the second switch, respectively, for chagrining batteries of a stationary work machine via dispensers. In a dynamic energy transfer (DET) mode of the energy transfer system, the first switch and the second switch are open and the rail switch is closed, and the first plurality of inverters and the second plurality of inverters are connected in series to provide DC voltage equal to the sum of the first DC voltage and the second DC voltage for providing DC power to a moving work machine via power rails.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. A configurable energy transfer interface comprising:
a first positive switch including:
a first positive switch input configured to receive first positive DC voltage of first DC voltage, and
a first positive switch output configured to provide the first positive DC voltage when the first positive switch is closed;
a first negative switch including:
a first negative switch input configured to receive first negative DC voltage of the first DC voltage, and
a first negative switch output configured to provide the first negative DC voltage when the first negative switch is closed;
a second positive switch including:
a second positive switch input configured to receive second positive DC voltage of second DC voltage, and
a second positive switch output configured to provide the second positive DC voltage when the second positive switch is closed;
a second negative switch including:
a second negative switch input configured to receive second negative DC voltage of the second DC voltage, and
a second negative switch output configured to provide the second negative DC voltage when the second negative switch is closed;
a rail positive switch including:
a rail positive switch input coupled to the first positive switch input to receive the first positive DC voltage, and
a rail positive switch output configured to provide the first positive DC voltage when the rail positive switch is closed;
a rail negative switch including:
a rail negative switch input coupled to the second negative switch input to receive the second negative DC voltage, and
a rail negative switch output configured to provide the second negative DC voltage when the rail negative switch is closed; and
a rail series switch including:
a rail series switch input coupled to the first negative switch input to receive the first negative DC voltage, and
a rail series switch output coupled to the second positive switch input to connect the first negative switch input and the second positive switch input to provide the first DC voltage and the second DC voltage in series when the rail series switch is closed.

2. The configurable energy transfer interface of claim 1, further comprising:
a first switch including the first positive switch and the first negative switch;
a second switch including the second positive switch and the second negative switch; and
a rail switch including the rail positive switch, the rail negative switch, and the rail series switch,
wherein:
when the first switch is open, the first positive switch and the first negative switch are open,
when the first switch is closed, the first positive switch and the first negative switch are closed,
when the second switch is open, the second positive switch and the second negative switch are open,
when the second switch is closed, the second positive switch and the second negative switch are closed,
when the rail switch is open, the rail positive switch, the rail negative switch, and the rail series switch are open, and
when the rail switch is closed, the rail positive switch, the rail negative switch, and the rail series switch are closed.

3. The configurable energy transfer interface of claim 2, wherein:
in a bulk charging mode of the configurable energy transfer interface, the first switch and the second switch are closed and the rail switch is open, and
in a dynamic energy transfer (DET) mode of the configurable energy transfer interface, the first switch and the second switch are open and the rail switch is closed.

4. The configurable energy transfer interface of claim 3, further comprising:
a switch controller coupled to the first switch, the second switch, and the rail switch, the switch controller configured to:
based on receiving a bulk charge activation command for the bulk charging mode, cause the first switch, the second switch, and the rail switch to operate in the bulk charging mode, and
based on receiving a DET activation command for the DET mode, cause the first switch, the second switch, and the rail switch to operate in the DET mode.

5. The configurable energy transfer interface of claim 4, wherein the switch controller is remotely operable.

6. The configurable energy transfer interface of claim 4, wherein the switch controller is further configured to:
based on receiving a deactivation command, cause the first switch, the second switch, and the rail switch to open.

7. The configurable energy transfer interface of claim 1, wherein:
the first positive switch input is further configured to couple to a first positive DC output of a first plurality of inverters,
the first negative switch input is further configured to couple to a first negative DC output of the first plurality of inverters,
the second positive switch input is further configured to couple to a second positive DC output of a second plurality of inverters, and
the second negative switch input is further configured to couple to a second negative DC output of the second plurality of inverters.

8. The configurable energy transfer interface of claim 7, wherein inverters of the first plurality of inverters and the second plurality of inverters are of a same type and have a same capacity.

9. The configurable energy transfer interface of claim 7, wherein the first plurality of inverters includes a same number of inverters as the second plurality of inverters.

10. The configurable energy transfer interface of claim 7, wherein:
an external AC source is coupled to a primary winding of a three-winding transformer,
the first plurality of inverters is coupled to a secondary winding of the three-winding transformer, and
the second plurality of inverters is coupled to a tertiary winding of the three-winding transformer.

11. An energy transfer system comprising:
a configurable energy transfer interface comprising:
a first positive switch including:
a first positive switch input configured to receive first positive DC voltage of first DC voltage, and
a first positive switch output configured to provide the first positive DC voltage when the first positive switch is closed,
a first negative switch including:
a first negative switch input configured to receive first negative DC voltage of the first DC voltage, and
first negative switch output configured to provide the first negative DC voltage when the first negative switch is closed;
a second positive switch including:
a second positive switch input configured to receive second positive DC voltage of second DC voltage, and
a second positive switch output configured to provide the second positive DC voltage when the second positive switch is closed,
a second negative switch including:
a second negative switch input configured to receive second negative DC voltage of the second DC voltage, and
a second negative switch output configured to provide the second negative DC voltage when the second negative switch is closed,
a rail positive switch including:
a rail positive switch input coupled to the first positive switch input to receive the first positive DC voltage, and
a rail positive switch output configured to provide the first positive DC voltage when the rail positive switch is closed,
a rail negative switch including:
a rail negative switch input coupled to the second negative switch input to receive the second negative DC voltage, and
a rail negative switch output configured to provide the second negative DC voltage when the rail negative switch is closed, and
a rail series switch including:
a rail series switch input coupled to the first negative switch input to receive the first negative DC voltage, and
a rail series switch output coupled to the second positive switch input to connect the first negative switch input and the second positive switch input to provide the first DC voltage and the second DC voltage in series when the rail series switch is closed;
a first plurality of inverters including:
a first positive DC output coupled to the first positive switch input, and
a first negative DC output coupled to the first negative switch input,
a second plurality of inverters including:
a second positive DC output coupled to the second positive switch input, and
a second negative DC output coupled to the second negative switch input; and
a three-winding transformer configured to receive AC power from an external AC source, the three-winding transformer including:
a primary winding configured to couple to the external AC source,
a secondary winding coupled to the first plurality of inverters, and
a tertiary winding coupled to the second plurality of inverters.

12. The energy transfer system of claim 11, wherein the configurable energy transfer interface further comprises:
a first switch including the first positive switch and the first negative switch;
a second switch including the second positive switch and the second negative switch; and
a rail switch including the rail positive switch, the rail negative switch, and the rail series switch,
wherein:
when the first switch is open, the first positive switch and the first negative switch are open,
when the first switch is closed, the first positive switch and the first negative switch are closed,
when the second switch is open, the second positive switch and the second negative switch are open,
when the second switch is closed, the second positive switch and the second negative switch are closed,
when the rail switch is open, the rail positive switch, the rail negative switch, and the rail series switch are open, and
when the rail switch is closed, the rail positive switch, the rail negative switch, and the rail series switch are closed.

13. The energy transfer system of claim 12, wherein:
in a bulk charging mode of the energy transfer system, the first switch and the second switch are closed and the rail switch is open, and
in a dynamic energy transfer (DET) mode of the energy transfer system, the first switch and the second switch are open and the rail switch is closed.

14. The energy transfer system of claim 13, further comprising:
a switch controller coupled to the first switch, the second switch, and the rail switch, the switch controller configured to:
based on receiving a bulk charge activation command for the bulk charging mode, cause the first switch, the second switch, and the rail switch to operate in the bulk charging mode, and
based on receiving a DET activation command for the DET mode, cause the first switch, the second switch, and the rail switch to operate in the DET mode.

15. The energy transfer system of claim 14, wherein the switch controller is remotely operable.

16. The energy transfer system of claim 11, wherein:
inverters of the first plurality of inverters and the second plurality of inverters are of a same type and have a same capacity, and
the first plurality of inverters includes a same number of inverters as the second plurality of inverters.

17. A method, comprising:
receiving first positive DC voltage of first DC voltage by:
a first positive switch input of a first positive switch of a configurable energy transfer interface, and
a rail positive switch input of a rail positive switch of the configurable energy transfer interface;
receiving first negative DC voltage of the first DC voltage by:
a first negative switch input of a first negative switch of the configurable energy transfer interface, and
a rail series switch input of a rail series switch of the configurable energy transfer interface;
receiving second positive DC voltage of second DC voltage by:
a second positive switch input of a second positive switch of the configurable energy transfer interface, and
a rail series switch output of the rail series switch;
receiving second negative DC voltage of the second DC voltage by:
a second negative switch input of a second negative switch of the configurable energy transfer interface, and
a rail negative switch input of a rail negative switch of the configurable energy transfer interface;
in a bulk charging mode of the configurable energy transfer interface:
closing the first positive switch to provide the first positive DC voltage at a first positive switch output of the first positive switch,
closing the first negative switch to provide the first negative DC voltage at a first negative switch output of the first negative switch,
closing the second positive switch to provide the second positive DC voltage at a second positive switch output of the second positive switch, and
closing the second negative switch to provide the second negative DC voltage at a second negative switch output of the second negative switch; and
in a dynamic energy transfer (DET) mode of the configurable energy transfer interface:
closing the rail positive switch to provide the first positive DC voltage at a rail positive switch output of the rail positive switch,
closing the rail negative switch to provide the second negative DC voltage at a rail negative switch output of the rail negative switch, and
closing the rail series switch to connect the first negative switch input and the second positive switch input to provide the first DC voltage and the second DC voltage in series.

18. The method of claim 17, further comprising:
in the bulk charging mode, opening the rail positive switch, the rail negative switch, and the rail series switch; and
in the DET mode, opening the first positive switch, the first negative switch, the second positive switch, and the second negative switch.

19. The method of claim 18, further comprising one of:
operating in the bulk charging mode based on receiving, by a switch controller of the configurable energy transfer interface, a bulk charge activation command for the bulk charging mode, or
operating in the dynamic energy transfer mode based on receiving, by the switch controller, a DET activation command for the dynamic energy transfer mode,
wherein the switch controller is coupled to the first positive switch, the first negative switch, the second positive switch, the second negative switch, the rail positive switch, the rail negative switch, and the rail series switch.

20. The method of claim 19, wherein the bulk charge activation command and DET activation command are transmitted from a controlling device remotely located from the configurable energy transfer interface to the switch controller.
